(19) United States
(12) Patent Application Publication
(10) Pub. No.: US 2024/0300125 A1
(43) Pub. Date: Sep. 12, 2024

(54) Showerless Razor

(71) Applicant: Magic Street Inc., Houston, TX (US)

(72) Inventor: Deborah Suzanne Cohen Zager, Houston, TX (US)

(73) Assignee: Magic Street Inc., Houston, TX (US)

(21) Appl. No.: 18/119,265

(22) Filed: Mar. 8, 2023

(51) Int. Cl. B26B 21/44; B26B 21/52

(52) U.S. Cl. CPC B26B 21/446; B26B 21/521; B26B 21/225

(57) ABSTRACT

A showerless razor is disclosed that has a deformable handle containing a liquid where the liquid is dispensed through a dispensing port located near a shaving blade. The liquid is dispensed by means of squeezing or otherwise deforming the handle of the showerless razor. The showerless razor can be easily refilled with a refill bag containing a liquid where the liquid in the refill bag is transferred to the handle of the showerless razor by compressing the refill bag such that the liquid passes into the handle of the showerless razor through a refill valve located in the deformable handle.

### BACKGROUND OF THE INVENTION

### 1. Field of the Invention

This invention relates generally to razors for shaving, and more specifically to a razor having a fluid dispensing arrangement for showerless shaving.

### 2. Description of Related Art

Shaving has been a form of cleanliness, grooming and hygiene going back tens of thousands of years. In ancient Egypt, for example, shaving was indicative of wealth and status in society. Wealthier individuals in Egypt could afford to frequent a barber, and were thus often clean shaven. In the 1700's, the first safety razor was invented by Jean-Jacques Perret, and in 1847 William Henson designed the first modern T-handled razor, a design that is prevalent to this day. By 1900 King Camp Gillette created disposable razor cartridges, which are still predominant in the market today.

While shaving was originally for facial hair and was directed largely at men, by 1915 women began shaving their legs and armpits. This trend was largely due to changes in clothing styles. Prior to around 1915, women wore clothing with extensive coverage. As styles began to change, women's clothing slowly became more revealing. The popularity of skirts in the 1950's increased the popularity of women's shaving, as did the increasingly popular sleeveless dress in the 1920's.

As women generally have more tender skin than men, the use of razors designed for men were not well received by most women. As a result, razors designed specifically for women began to evolve along with a myriad of shaving products for women. It became commonplace for women to shave their legs and armpits in a shower or bath, as the water provided a suitable lubricating fluid and also aided in washing the shaving debris away from the skin. Shaving while in the shower or bath proved to be convenient and gentle on skin. Unfortunately there were times when shaving was desired but it was not convenient to shower or bathe. Of course there were various shaving lotions, creams and soaps available, but they often required application prior to shaving, and their removal afterwards.

What is therefore needed is a razor that provides a self contained and easy to dispense lubricating liquid such that the application of outside lubricating liquids or water is not necessary during the process of shaving.

### BRIEF SUMMARY OF THE INVENTION

In accordance with the present invention, there is provided a showerless razor comprising a head having a blade recess configured to receive a shaving blade and having a dispensing port through the head; a bracket mechanically coupled to the head; a handle comprising a deformable material wherein the handle contains a lubricant bag in fluid communication with the dispensing port; a refill valve in fluid communication with the lubricant bag; and a retention wing mechanically coupled to the handle; the retention wing being pivotally attached to the bracket to allow for pivotal motion of the head in relation to to the handle. The showerless razor also has a refill bag that can be coupled to the handle of the showerless razor to refill the lubricant bag within the handle.

The foregoing paragraph has been provided by way of introduction, and is not intended to limit the scope of the invention as described in this specification, claims and the attached drawings.

### BRIEF DESCRIPTION OF THE DRAWINGS

The invention will be described by reference to the following drawings, in which like numerals refer to like elements, and in which:

FIG. 1 is a perspective view of a showerless razor of the present invention;

FIG. 2 is a front plan view of the showerless razor;

FIG. 3 is a side plan view of the showerless razor:

FIG. 4 is a back plan view of the showerless razor;

FIG. 5 is an alternate side plan view of the showerless razor;

FIG. 6 is a top plan view of the showerless razor;

FIG. 7 is a bottom plan view of the showerless razor;

FIG. 8 is a perspective view of the showerless razor with the blade removed;

FIG. 9 is a cutaway view of the showerless razor taken along line A-A of FIG. 4;

FIG. 10 is a perspective view of the showerless razor with a refill bag attached;

FIG. 11 is an exploded view of the showerless razor with the refill mechanism shown; and

FIG. 12 is a cutaway view of the showerless razor and refill bag taken along line B-B of FIG. 10.

The attached figures depict various views of the showerless razor in sufficient detail to allow one skilled in the art to make and use the present invention. These figures are exemplary, and depict a preferred embodiment; however, it will be understood that there is no intent to limit the invention to the embodiment depicted herein. On is the contrary, the intent is to cover all alternatives, modifications, and equivalents as may be included within the spirit and scope of the invention as defined by this specification, claims and drawings.

### DESCRIPTION OF THE PREFERRED EMBODIMENTS

A showerless razor and refill mechanism is described and depicted by way of this specification and the attached drawings.

The showerless razor of the present invention has a removable shaving head along with a novel lubricant dispensing handle that interacts with the shaving head to provide a lubricant or other fluid at or near the point of shaving. Such an arrangement facilitates an improved shaving experience, improves the overall quality of the shave, improves the condition of the skin being shaved, and provides a convenient way to dispense a shaving to fluid while shaving.

For a general understanding of the present invention, reference is made to the drawings. In the drawings, like reference numerals have been used throughout to designate identical elements.

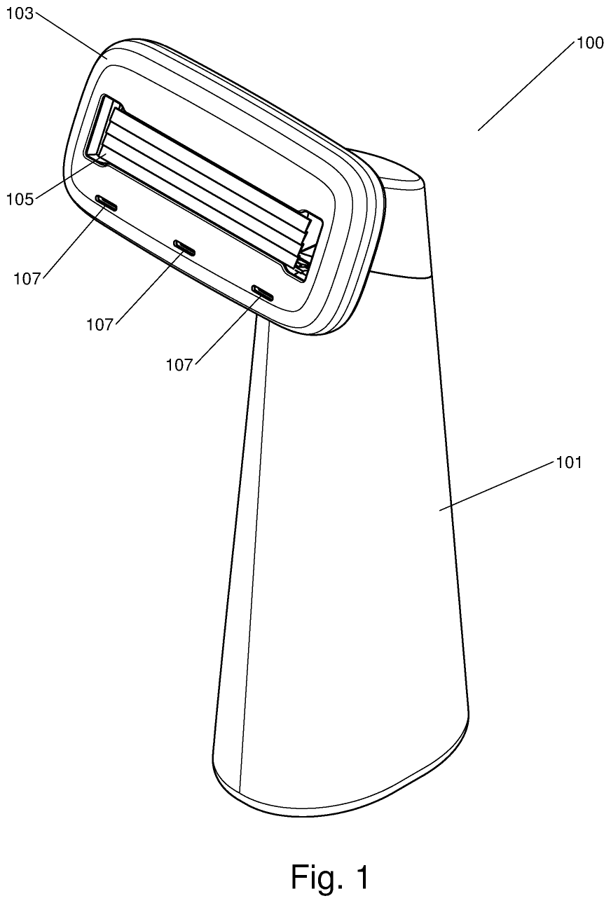

Referring to FIG. 1, a perspective view of the showerless razor 100 is shown. Depicted is a showerless razor 100 comprising a handle 101 and a head 103. The head 103 pivots or rotates with respect to the handle 101, and in some embodiments is removable. A shaving blade 105 can be seen within a recess in the head 103. In some preferred embodiments of the present invention, the shaving blade 105 is removable and replaceable. In other embodiments of the present invention, the shaving blade 105 and the head 103 are replaceable as a unit. The shaving blade 105 is typically made from a metal such as a stainless steel or a hygienic steel alloy that is capable of being sharpened. The shaving blade 105 may include a plurality of blades (such as the four blades depicted in FIG. 1, three blades, two blades, or the like). The head 103 can be seen as a generally rectangular shape with rounded corners. The general shape of the head 103 may vary from that depicted in the figures without departing from the spirit and broad scope of the present invention as defined herein. Several dispensing ports 107 can be seen in FIG. 1, specifically through the head 103. As will be further described herein, a lubricant bag contained in the handle 101 is in fluid communication with the dispensing ports 107. In the embodiment depicted by way of example in FIG. 1, there are three dispensing ports 107. In other embodiments, there may be more or fewer than three dispensing ports 107. In some embodiments of the present invention there may be one dispensing port. When an embodiment defines more than one dispensing port, the dispensing ports may be interconnected by any of a variety of means, such as by way of a conduit or channel defined within the head 103, by way of tubing or other fluid carrying structure, or the like. The figures depict an exemplary embodiment of the present invention where the dispensing ports 107 are configured as slits. It should be noted that other geometries of the dispensing ports are included in the various embodiments described, depicted and envisioned herein. For example, the dispensing ports may be round, is square, elongated, hexagonal, or may include protrusions or other features.

The various components of the showerless razor 100 may be made from materials such as plastics, metals, composites, wood, or the like. Examples of suitable plastics include acrylonitrile butadiene styrene (ABS), polyethylene, polypropylene, polystyrene, polyvinyl chloride, polytetrafluoroethylene, and the like. Bioplastics may also be used in some embodiments of the present invention. The various components of the showerless razor 100 may be made by injection molding, blow molding, machining, or the like.

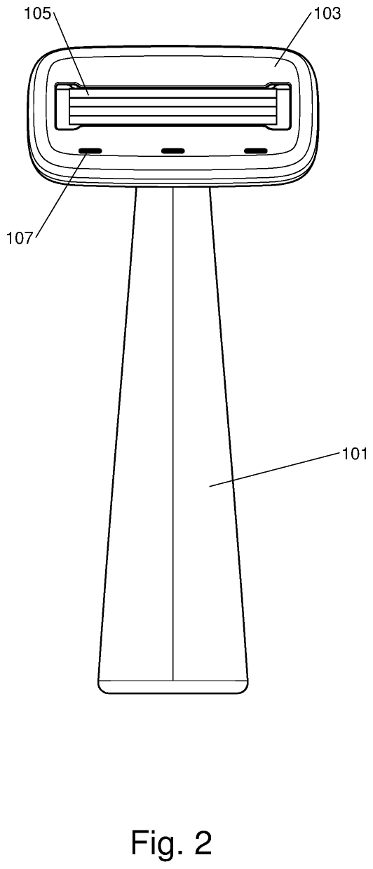

To further a complete understanding of the showerless razor of the present invention, FIGS. 2-6 depict various views thereof.

FIG. 2 is a front plan view of the showerless razor clearly depicting the head 103 with attached shaving blade 105 and dispensing ports 107. The handle 101 can be seen attached to the head 103.

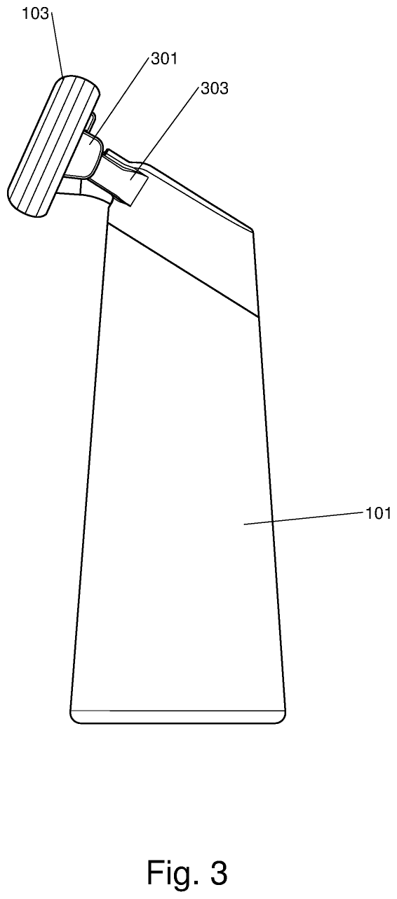

FIG. 3 is a side plan view of the showerless razor. In FIG. 3, a head bracket 301 can be seen which is mechanically coupled or otherwise molded or formed with the head 103. In addition, a retention wing 303 can be seen mechanically coupled or otherwise molded or formed with the handle 101. In the example depicted in FIG. 3, there are two retention wings 303 and two head brackets 301, where each retention wing 303 is pivotally attached to the head bracket 301 to allow for pivotal motion of the head in relation to the handle. This pivotal motion provides for an improved shave by allowing the head 103 and associated shaving blade 105 to move or pivot during shaving. The retention wings 303 and the head brackets 301 may, in some embodiments of the present invention, be removably attached to each other. FIG. 3 also depicts the handle 101. As seen in FIG. 3, the lower or base portion of the handle 101 is larger than the upper or head portion of the handle. This is allows for the showerless razor to stand upright when not in use. In some embodiments of the present invention, the base portion of the handle 101 is angled or offset to provide a slight angle or offset to the showerless razor when standing or resting on a counter or the like.

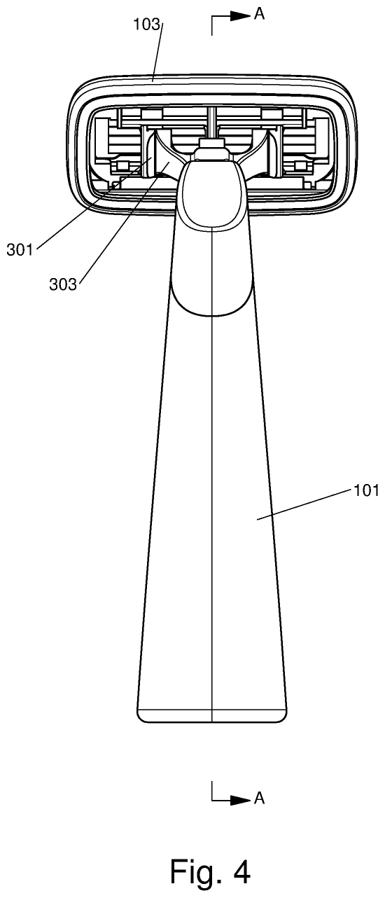

FIG. 4 is a back plan view of the showerless razor clearly showing the interaction between the head bracket 301 and the retention wing 303. In some embodiments, a stop or attachment member may be present. Further, in some embodiments, a spring may be in communication with a tab or stop that in turn engages with the head 103.

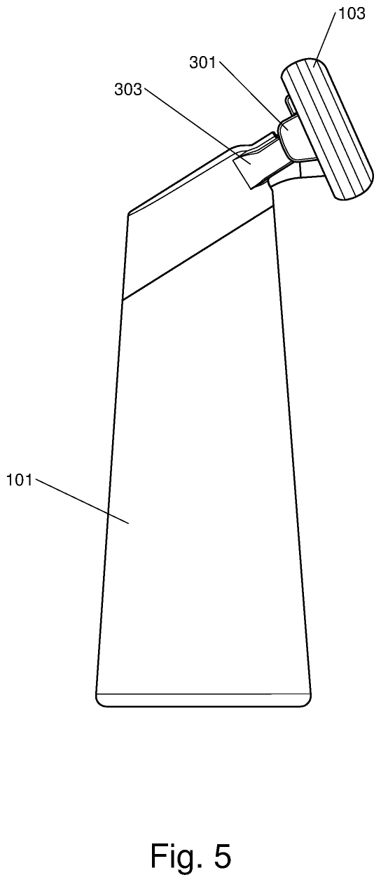

FIG. 5 is an alternate side plan view of the showerless razor showing the head 103 pivotally attached to the handle 101.

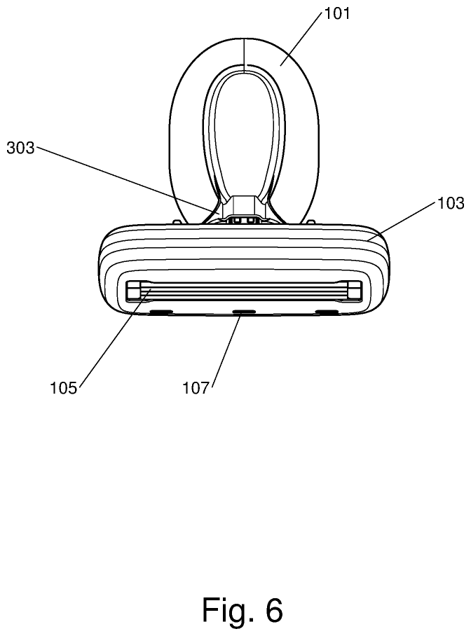

FIG. 6 is a top plan view of the showerless razor where the retention wings 303 can be seen attaching to the head brackets 301.

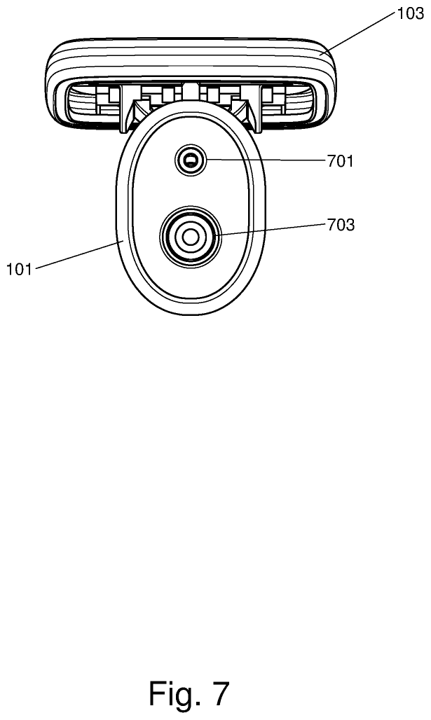

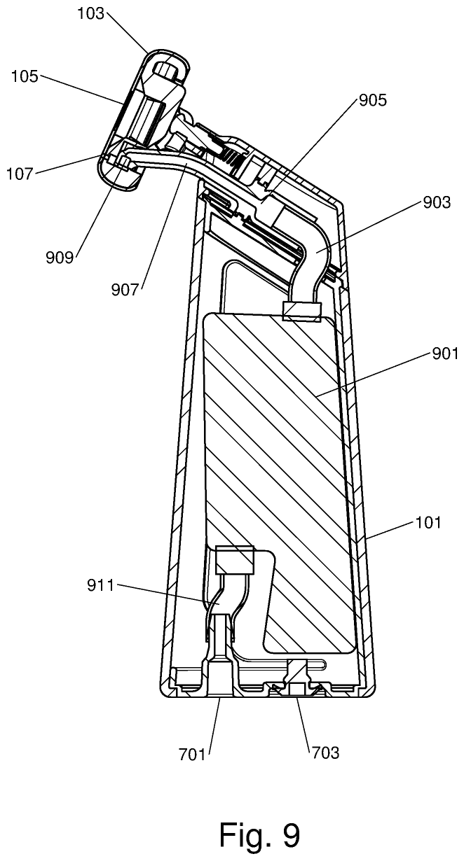

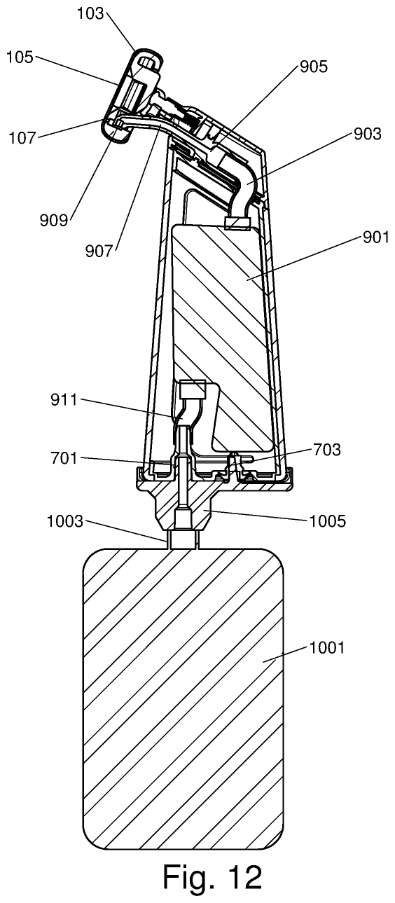

FIG. 7 is a bottom plan view of the showerless razor where the bottom of the handle 101 can be seen. As will be further explained herein, the handle 101 comprises a deformable material and contains a lubricant bag in fluid communication with the dispensing port 107 of the head 103. While the deformable material of the handle 101 may be made from a soft durometer plastic or rubber, it may also simply be a plastic where the handle 101 is molded with a wall thickness that allows for the handle 101 to deform when squeezed. The act of squeezing or otherwise deforming the handle 101 forces the lubricant or other liquid contained in the lubricant bag within the handle 101 to move through a passageway or conduit and out the dispensing port 107 of the head 103. In some embodiments of the present invention, the handle 101 is airtight such that when the handle 101 is squeezed or otherwise deformed the resulting pressure increase within the handle 101 causes the lubricant bag within the handle to compress, thus expelling the lubricant or other liquid contained is therein. To facilitate such use of pressure within the handle 101, a one way valve 703 is fitted to the handle 101. In some embodiments of the present invention, the one way valve 703 is fitted to the underside or bottom of the handle 101, as can be seen in FIG. 7. The underside, bottom or base of the handle 101, as seen in FIG. 7, may be made from a plastic that preferably does not deform (unlike the majority of the handle 101). The one way valve 703 allows air to enter the handle 101, but not exit, essentially allowing for the exchange of air within the handle when the handle is squeezed or otherwise deformed. This allows for a buildup of pressure within the handle 101 sufficient to expel lubricants or other liquids from a lubricant bag contained within the handle 101. Such a lubricant bag and related fluid flow structures can be seen in FIG. 9, and will be further described herein. A refill valve 701 can also be seen through the bottom of the handle 101. In one embodiment of the present invention, the refill valve 701 is adjacent to the one way valve, but may, in other embodiments, be placed elsewhere on the handle 101. As will be further described by way of FIGS. 9 and 12, the refill valve 701 is fluidly connected to a lubricant bag within the handle 101. The refill valve allows for the entry, but not the exit, of a liquid such as a lubricant, from a refill bag into the lubricant bag within the handle 101 showerless razor. Both the refill valve 701 and the one way valve 703 may be made from a material such as a plastic, and may contain, in some embodiments, a flexible membrane or a flap that is hinged to with a stop on one side, allowing movement in one direction only, thus creating a one way valve. Other one way valves may also, in some embodiments, be employed.

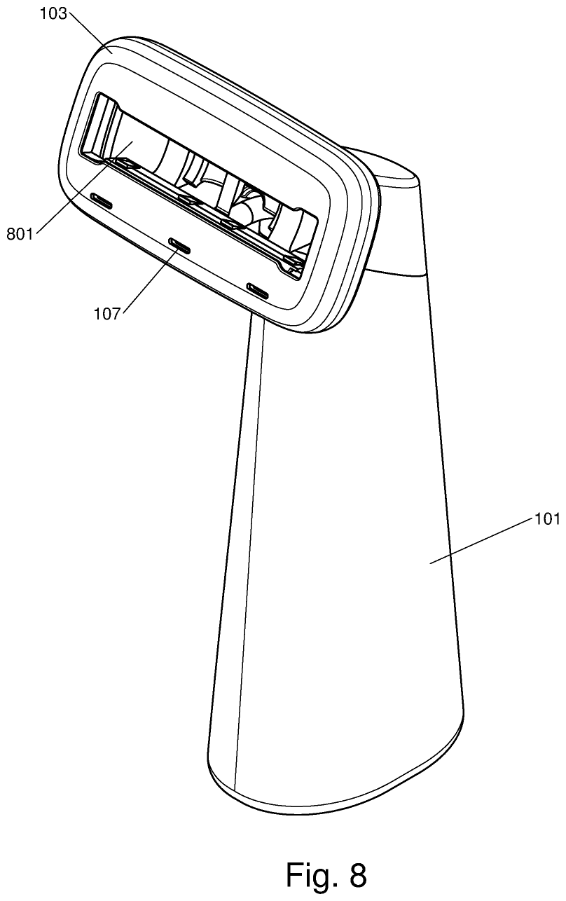

Turning now to FIG. 8, a perspective view of the showerless razor with the blade removed is depicted. A blade recess 801 can be seen where a removable and disposable blade is placed. The disposable blade is retained in the blade recess 801 by tabs, wedges, clips, or is the like. A blade removal feature may also, in some embodiments, be provided. The blade removal feature may be an engaging element that pushes the disposable blade out of the blade recess 801, or it may be a lever, a hinge, a wedge, a pin, or the like that transfers force from the user to the disposable blade in such a manner as to remove the disposable blade from the blade recess 801.

FIG. 9 is a cutaway view of the showerless razor taken along line A-A of FIG. 4 that clearly shows the inner workings of the handle 101. A lubricant bag 901 for containing lubricant or a similar liquid can be seen. The lubricant bag 901 may be made from a polyethylene or a polypropylene plastic, or other suitable material. The lubricant bag 901 conforms to the inner space defined by the handle 101, and has an inlet and an outlet. The inlet is provided to refill the lubricant bag 901 and comprises a refill manifold 911 which is in turn coupled to the refill valve 701, thus providing a liquid conduit between the refill valve 701 and the lubricant bag 901. The refill manifold 911 may also be made from a suitable plastic, such as, but not limited to, acrylonitrile butadiene styrene (ABS), polyethylene, polypropylene, polystyrene, polyvinyl chloride, polytetrafluoroethylene, bioplastics, and the like. The refill manifold 911 is bonded to the lubricant bag 901 through known bonding techniques such as thermal or chemical bonding. The refill manifold 911 is coupled to the body of the refill valve 701 through mechanical means, which may include, but is not limited to, press fit or threaded fastening, adhesive fastening, thermal fastening, single piece molding or manufacturing, or the like. The outlet of the lubricant bag 901 comprises a lubricant manifold 903 that may, in some embodiments of the present invention, be connected to a lubricant conduit 907 by way of a reducer 905, thus providing a liquid conduit between the lubricant bag 901 and the lubricant emitter 909. The lubricant manifold 903, the lubricant is conduit 907 and the reducer 905 may be made from a suitable plastic, such as, but not limited to, acrylonitrile butadiene styrene (ABS), polyethylene, polypropylene, polystyrene, polyvinyl chloride, polytetrafluoroethylene, bioplastics, and the like. The lubricant manifold 903 is bonded to the lubricant bag 901 through known bonding techniques including thermal and chemical bonding. The lubricant manifold 903 is coupled to the lubricant conduit 907 by way of the reducer 905 through mechanical means, which may include, but is not limited to, press fit or threaded fastening, adhesive fastening, thermal fastening, single piece molding or manufacturing, or the like. The lubricant emitter 907 is fluidly coupled to the dispensing port 107 or plurality of dispensing ports 107 by way of a channel, conduit, or similar fluid conveying structure. In some embodiments, this fluid conveying structure is molded into the head 103.

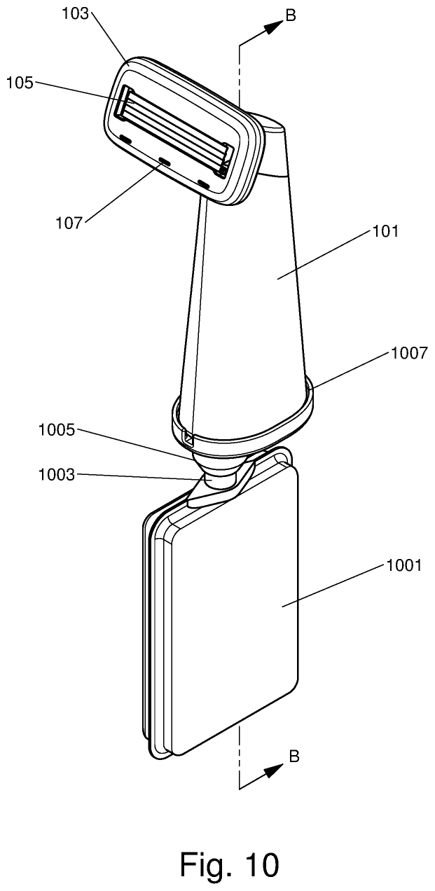

FIG. 10 is a perspective view of the showerless razor with a refill bag 1001 attached, thus also illustrating how to refill the showerless razor. The refill bag 1001 can be seen attached to the showerless razor. The refill bag 1001 may be made from a polyethylene or a polypropylene plastic, or other suitable material. A refill bag coupler 1003 can be seen connected or joined with a refill bag union 1005. The refill bag coupler 1003 and the refill bag union 1005 may also be made from a suitable plastic, such as, but not limited to, acrylonitrile butadiene styrene (ABS), polyethylene, polypropylene, polystyrene, polyvinyl chloride, polytetrafluoroethylene, bioplastics, and the like. The refill bag coupler 1003 is bonded to the refill bag 1001 through known bonding techniques such as thermal or chemical bonding. The refill bag union 1005 contains a fitting which is configured to mate with the refill valve 701 and provide a liquid tight seal such that the lubricant or other liquid contained in the refill bag 1001 transfers from the refill bag 1001 into the lubricant bag 901 is by way of the refill valve 701 without leaks or spills. In some embodiments, a suitable gasket or seal is provided between the refill valve 701 and the refill bag union 1005. To use the refill bag 1001, connection is made between the refill bag union 1005 and the refill valve 701, and the refill bag 1001 is squeezed or otherwise deformed such that the refill liquid contained within the refill bag 1001 is extruded into the lubricant bag 901 contained within the handle 101 of the showerless razor 100.

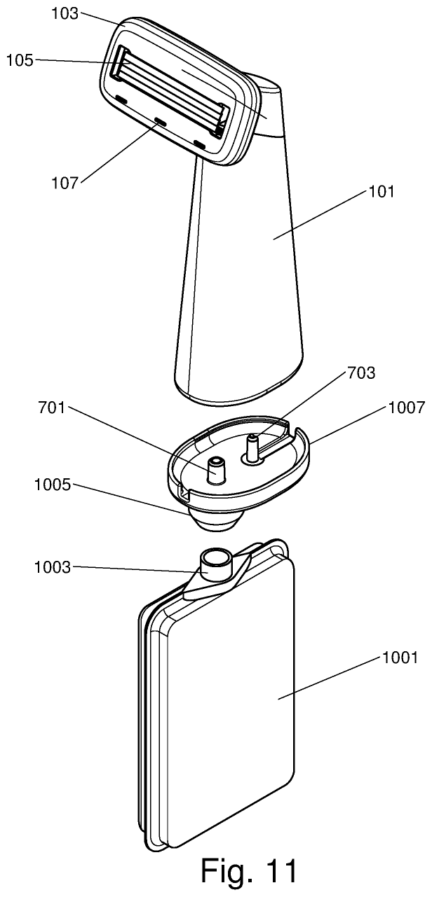

FIG. 11 is an exploded view of the showerless razor with the refill mechanism shown. The refill bag 1001 can be seen with the refill bag coupler 1003 along with the refill bag union 1005 joined to the refill valve 701 which is joined to the handle base 1007. Also connected or joined with the handle base 1007 is the one way valve 703 which has been previously described.

Lastly, FIG. 12 is a cutaway view of the showerless razor and refill bag taken along line B-B of FIG. 10. The fluid communication channel between the refill bag 1001 and the lubricant bag 901 can be clearly seen, and has been previously described herein.

To use the showerless razor, the skin to be shaven may first be moistened with the lubricating fluid contained within the lubricant bag by squeezing or deforming the handle 101 with the head 103 close to or touching the skin such that lubricating fluid is dispensed from the dispensing ports 107. Lubricating fluid may be dispensed in a similar manner until to shaving is completed. The showerless razor otherwise works the same way a traditional razor works, where the head 103 is moved across the skin to be shaven while allowing the unwanted hair to be cut by the blade 105 contained within the head 103.

It is, therefore, apparent that there has been provided, in accordance with the various objects of the present invention, a showerless razor and refill mechanism. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims and the attached drawings.

What is claimed is:

1. A showerless razor comprising:
a head having a blade recess configured to receive a shaving blade with a dispensing port through the head;
a bracket mechanically coupled to the head;
a handle comprising a deformable material wherein the handle contains a lubricant bag in fluid communication with the dispensing port;
a refill valve in fluid communication with the lubricant bag;
a retention wing mechanically coupled to the handle;
the retention wing being pivotally attached to the bracket to allow for pivotal motion of the head in relation to the handle.

2. The showerless razor of claim 1, further comprising a one way valve attached to the handle to allow for the exchange of air within the handle when the handle is deformed.

3. The showerless razor of claim 1, further comprising a lubricant manifold mechanically coupled to the lubricant bag and configured to remove lubricant from the lubricant bag toward the dispensing port.

4. The showerless razor of claim 1, further comprising a lubricant conduit in fluid communication between the lubricant bag and the dispensing port.

5. The showerless razor of claim 1, further comprising a reducer connected between the lubricant manifold and the lubricant conduit.

6. The showerless razor of claim 1, further comprising an emitter connected between the lubricant conduit and the dispensing port.

7. The showerless razor of claim 1, further comprising a refill manifold connected between the refill valve and the lubricant bag.

8. The showerless razor of claim 1, wherein the refill valve is located at the bottom of the handle.

9. The showerless razor of claim 1, wherein the one way valve is located at the bottom is of the handle.

10. The showerless razor of claim 1, further comprising a shaving blade.

11. The showerless razor of claim 10, wherein the shaving blade is disposable.

12. The showerless razor of claim 1, wherein the lubricant bag comprises lubricant.

13. The showerless razor of claim 1, further comprising a refill bag union mechanically coupled to the refill valve.

14. A showerless razor comprising:
a head having a blade recess configured to receive a shaving blade with a dispensing port through the head;
a bracket mechanically coupled to the head;
a handle comprising a deformable material wherein the handle contains a lubricant bag in fluid communication with the dispensing port;
a refill valve in fluid communication with the lubricant bag;
a retention wing mechanically coupled to the handle;
the retention wing being pivotally attached to the bracket to allow for pivotal motion of the head in relation to the handle; and
a shaving blade.

15. The showerless razor of claim 14, further comprising a one way valve attached to the handle to allow for the exchange of air within the handle when the handle is deformed.

16. The showerless razor of claim 14, wherein the shaving blade is disposable.

17. A kit for showerless shaving, the kit comprising:
the showerless razor of claim 1;
a shaving blade; and
a refill bag comprising a lubricant.

18. A refill bag for the showerless razor of claim 1, the refill bag comprising:
a deformable bag suitable for containing a fluid; and
a refill bag coupler attached to the deformable bag and configured to receive a refill bag union.

19. The refill bag of claim 18, further comprising a liquid contained in the deformable bag.

20. The refill bag of claim 18, wherein the liquid is a lubricant.
